(19) United States
(12) Patent Application Publication
(10) Pub. No.: US 2005/0269927 A1
(43) Pub. Date: Dec. 8, 2005

(54) Image display device

(75) Inventors: Shigemi Hirasawa, Chiba (JP); Yoshiyuki Kaneko, Hachioji (JP); Hiroshi Kawasaki, Ooamishirasato (JP); Yuuichi Kijima, Choseii (JP)

Correspondence Address: Christopher E. Chalsen;Milbank, Tweed, Hadley & McCloy LLP, 1 Chase Manhattan Plaza, New York, NY, 10005-1413, US

(73) Assignee: Hitachi Displays, Ltd.

(21) Appl. No.: 11/145,722

(22) Filed: Jun. 6, 2005

(30) Foreign Application Priority Data
Jun. 7, 2004 (JP) 2004-168275

(51) Int. Cl. H01J 19/42; H01J 1/62; H01J 63/04

(52) U.S. Cl. 313/292; 313/495

(57) ABSTRACT

A plurality of spacers are arranged between a face substrate and a back substrate of a planar image display device and both ends of each spacer are respectively fixed to the face substrate and the back substrate using a fixing material which contains a conductive component and 10 to 90 wt % of vitrifying component. Due to such a constitution, the display device can ensure the parallelism of both substrates and a panel strength by ensuring a fixing strength and conductive properties of the spacers. Accordingly, the display device can realize the large-sizing of a display size and the high-quality display. The display device also can prolong the lifetime.

### BACKGROUND OF THE INVENTION

The present invention relates to an image display device which emits electrons to a phosphor screen formed on a face substrate from electron sources formed on a back substrate, and more particularly to an image display device which can hold a parallelism of the back substrate and the face substrate with high accuracy.

As a display device which exhibits the high brightness and the high definition, color cathode ray tubes have been popularly used conventionally. However, along with the recent request for the higher quality of images of information processing equipment or television broadcasting, the demand for planar displays (panel displays) which are light-weighted and require a small space while exhibiting the high brightness and the high definition has been increasing.

As typical examples, liquid crystal display devices, plasma display devices and the like have been put into practice. Further, particularly, as display devices which can realize the higher brightness, various planar display devices have been put into practice. Here, these planar display devices include an electron emission type display device or a field emission type display device as a display device which utilizes an emission of electrons from electron sources into a vacuum or an organic EL display which exhibits the low power consumption or the like.

Among such planar display devices, as the above-mentioned field emission type display device, there have been known a display device having the electron emission structure which was invented by C. A. Spindt et al, a display device having an electron emission structure of metal-insulator-metal (MIM) type, a display device having an electron emission structure which utilizes an electron emission phenomenon based on a quantum theory tunneling effect (also referred to as “a surface conduction type electron source”), and a display device which utilizes an electron emission phenomenon which a diamond film, a graphite film and carbon nanotubes or the like possesses.

Among these panel type display devices, the field emission type display is formed by laminating a face substrate which is provided with anode electrodes and phosphor layers on an inner surface thereof and a back substrate on which field-emission-type cathodes and grid electrodes which constitute control electrodes are formed are laminated to each other with a gap of, for example, 0.5 mm or more, and these substrates are hermetically sealed to form a panel, and a sealed space which is defined between two substrates of the panel is held at a pressure lower than an atmospheric pressure of an ambient field or is evacuated into a vacuum.

Recently, as the field-emission type electron sources which constitute the cathodes of the planar display of this type, the use of carbon nanotubes (CNT) has been studied. The carbon nanotubes are formed by fixing a carbon nanotube aggregate which is formed by gathering a large number of extremely fine needle-like carbon compounds to the cathode electrode.

By applying an electric field to the cathode electrode having the carbon nanotubes, it is possible to allow the carbon nanotubes to emit electrons of high density with high efficiency and the phosphor is energized with these electrons thus providing various display devices or the flat panel display capable of displaying images or the like which exhibit the high brightness.

FIG. 11 is a cross-sectional view of an image forming device of one conventional example disclosed in Japanese Patent Laid-open Hei11(1999)-317164 (patent literature 1). This image forming device includes a face plate (face substrate) 1, a back plate (back substrate) 2, a support frame 3 which is arranged between the face plate 1 and the back plate 2 and supports peripheries of these plates, and spacers 4 which are arranged between the face plate 1 and the back plate 2 as support columns. The face plate 1 and the spacers 4 are bonded to each other using frit glass 7, while the back plate 2 and the spacers 4 are bonded to each other using frit glass 8. By bonding the face plate 1, the back plate 2 and the support fame 3 using frit glass 9 at a bonding portion between the face plate 1 and the support frame 3 and at a bonding portion between the face plate 2 and the support frame 3, a panel (an assembled vessel) is formed. The respective frit glasses 7, 8, 9 are configured to posses softening temperatures which differ from each other.

In the drawing, numeral 5 indicates a group of electron emission elements and numeral 6 indicates image forming members.

In this manner, the patent literature 1 discloses the constitution in which the spacers 4 which constitute the support columns are arranged between the face plate 1 and the back plate 2 so as to uniformly maintain a distance between the face plate 1 and the back plate 2 over the whole surface of the substrate.

For example, as the image forming member, the constitution which provides an anode electrode and a phosphor layer on the face substrate has been known. Further, as the electron emission element, there has been generally known the structure which provides a cathode line, a field-emission-type electron source which is electrically connected with the cathode line and is formed for every pixel, and a grid electrode which is arranged close to the field-emission-type electron source in an electrically insulated manner and is formed for every pixel to the back substrate or the like.

With respect to the above-mentioned planar display which is constituted of two substrates, the plasma display (PDP) and the planar display having the metal-insulator-metal type field emission sources (MIM-FED) also have the substantially equal constitution. Hereinafter, although the present invention will be explained by taking the field-emission-type display as an example, the present invention is also applicable to the PDP and the MIM-FED in the substantially same manner. Further, the present invention is also applicable to the display which uses the surface conduction elements (SED) in the substantially same manner.

Further, as the related art on this type of panel display, Japanese Patent Laid-open 2001-338528 (patent literature 2) discloses the constitution in which a back plate and spacers are bonded to each other using a sealing material which is formed by heating and baking sealing conductive frit which contains glass and at least one kind of metal selected from a group consisting of Si, Zn, Al, Sn, Mn, wherein members can be bonded to each other without generating a thermal stress and, at the same time, it is possible to impart the conductivity to the members.

### SUMMARY OF THE INVENTION

In the above-mentioned planar image display device, the electrons emitted from the electron sources impinge on the phosphor body which constitutes the anode after passing through apertures formed in the control electrode and excite the phosphor to emit light thus performing the display. Such an image display device provides the planar display which possesses excellent properties such as the high brightness and the high definition, is light-weighted and requires a small space.

However, in spite of such excellent structure, the planer image display device has following drawbacks to be overcome.

In the flat panel displays including the flat panel displays disclosed in the above-mentioned patent literatures 1 and 2, it is difficult to hold and fix the distance holding members (hereinafter referred to as spacers) arranged in the inside of a display region between both substrates in a state that the spacers are set free from the positional displacement and the inclination and hence, it is difficult to maintain the parallelism of both substrates and, at the same time, it is also difficult to ensure a sufficient panel strength.

Further, the conventional flat panel display has a drawback that the spacers are damaged and the electrodes or the like are damaged due to the damaged spacers. Further, in the conventional flat panel display, by adding a step to fix the spacers, there arises a possibility that cracks or leaks occur at hermetically sealed portions.

To fix the spacers and both substrates, in general, frit glass which is equal to the frit glass used as a material of the hermetic sealing material is used. In the crystallized frit glass, the crystallization progresses due to heating for a long time, and physical property values such as the thermal expansion coefficient and the like are changed whereby there arises a possibility that cracks occur due to an impact or the like and, at the same time, the hermetic sealing is damaged and hence, leaking is generated thus lowering the degree of vacuum.

Further, the amorphous frit glass is softened due to the reheating temperature. Accordingly, the spacers which are once fixed by softening suffer from the positional displacement or the inclination whereby it is difficult to hold and fix the spacers at desired positions with high accuracy. Further, also due to the generation of the deflection of the substrate or the like, it is difficult to maintain the parallelism of both substrates and to ensure the panel strength. Further, there also arises a drawback that spacers are damaged.

On the other hand, in the constitution which selectively uses plural kinds of frit glasses having different softening temperatures for fixing the spacers as disclosed in the patent literature 1, in general, the frit glasses have properties which exhibit softening gradually depending on kinds thereof. For example, the softening starts from a temperature approximately 50° C. lower than a nominal value and hence, the fluctuation of temperature is taken for granted.

Accordingly, even when the plural kinds of frit glasses whose softening temperature difference is approximately 50° C. or less are used, it is almost impossible to hold the spacers in a state where the spacers are practically set free from the positional displacement and the inclination. Further, it is practically impossible to selectively use the plural kinds of frit glasses whose softening temperature difference exceeds 50° C. Accordingly, there has been a demand to cope with such drawbacks.

Further, in the constitution disclosed in the patent literature 2 in which the back plate and the spacers are bonded using the sealing material which is formed by heating and baking the sealing conductive frit which contains glass and at least one kind of metal selected from a group consisting of Si, Zn, Al, Sn, Mn, there arises a possibility that a conductive component and a vitrifying component are insufficiently bonded to each other whereby there has been a demand for further enhancement from a viewpoint of ensuring the conductivity and the panel strength.

The present invention provides an image display device which can overcome the above-mentioned drawbacks, can ensure a panel strength while holding the parallelism between both substrates by ensuring the fixing of spacers, can realize the large sizing of a display size and a high quality display, and can also prolong a lifetime thereof.

To overcome the above-mentioned drawbacks, the present invention is characterized by the constitution which allows a fixing material which fixes the spacers to both substrates to contain both of a conductive component and a vitrifying component and, at the same time, by specifying a component ratio of both components and the arrangement of the spacers.

Due to such constitutional features, the spacers can be reliably fixed and hence, it is possible to achieve the assurance of the parallelism of both substrates and the panel strength and the prevention of charging simultaneously.

By fixing the spacers using the fixing material which contains the conductive component and a vitrifying component and by setting the ratio of the vitrifying component of the fixing material to 10 to 90 wt %, it is possible to ensure the reliability of adhesion and fixing of the spacers and both substrates and hence, the distance between both substrates can be maintained at a desired value in cooperation with the frame and the enhancement of a mechanical strength of a panel is achieved thus providing an image display device which can realize the large-sizing of a display size and the high-quality display and can exhibit the long lifetime.

Further, since it is possible to prevent the charging, due to the stabilization of the potential in the panel, it is possible to achieve the assurance of beam locus and the prevention of sparks whereby the image display device with high-quality display can be realized.

By setting the ratio of the vitrifying component in the fixing material to 20 to 80 wt %, the low-temperature adhesion becomes possible and hence, while it is possible to realize the electrodes or the like of high quality and high performance by preventing the thermal damage on the electrodes or the like, it is also possible to realize the image display device which enables the large-sizing of the display size and the high-quality display and can prolong the lifetime. Particularly, by setting the ratio of the vitrifying component in the fixing material to 50 wt %, it is possible to sufficiently obtain the above-mentioned advantageous effects.

Further, it is possible to ensure the reliability of the adhesion and the fixing of the spacers and both substrates and, at the same time, it is possible to hold the distance between both substrates at a desired value in cooperation with the frame and, at the same time, the mechanical strength of the panel can be increased.

Further, since it is possible to prevent the charging, due to the stabilization of the potential in the panel, it is possible to achieve the assurance of beam locus and the prevention of sparks whereby the image display device with high-quality display can be realized.

By forming the conductive component of the fixing material using sinterable metal particles, the bonding between the conductive component and the vitrifying component is strengthened whereby the reliability of adhesion and fixing of the spacers and both substrates is ensured and, further, the charge prevention effect becomes apparent.

By forming the conductive component of the fixing material using a material substantially consisting of any one selected from a group consisting of silver, gold, nickel and platinum or an alloy which contains such a metal as a main component, the bonding between the conductive component and the vitrifying component is strengthened whereby the charge prevention effect becomes apparent and the reliability of adhesion and fixing of the spacers and both substrates is ensured.

By forming the conductive component of the fixing material using a material substantially consisting of any one selected from a group consisting of silver, nickel or an alloy which contains such a metal as a main component, the bonding between the conductive component and the vitrifying component is strengthened whereby it is possible to ensure the reliability of adhesion and fixing of the spacers and both substrates as well as the charge prevention effect and, at the same time, it is possible to ensure the stable and inexpensive supply of the conductive component.

By forming the vitrifying component using frit glass, it is possible to ensure the reliability of adhesion and fixing of the spacers and both substrates and, at the same time, it is possible to suppress the undesired emission of gas into the inside of the panel thus ensuring the desired electron beam quantity and preventing the generation of sparks whereby the image display device of high-display quality can be realized.

By forming the spacer using a plate-like ceramic member, it is possible to ensure the mechanical strength of the spacers per se and, at the same time, it is possible to ensure the reliability of adhesion and fixing between the spacers and both substrates.

Further, the distance between both substrates can be maintained at a desired value in cooperation with the frame and the enhancement of a mechanical strength of a panel is achieved thus providing an image display device which can realize the large-sizing of a display size and the high-quality display and can exhibit the long lifetime.

Further, it is possible to produce the spacers per se on a mass production basis and hence, it is possible to obtain the spacers at a low cost.

In the arrangement of the spacers, a plurality of spacers are arranged in one direction at a given pitch and are arranged in a plurality of columns in another direction which intersects the above-mentioned one direction and hence, it is possible to hold the distance between both substrates at a desired value over the whole surface of the substrate whereby it is possible to enhance the mechanical strength of the panel. Accordingly, it is possible to provide an image display device which can realize the large-sizing of a display size and the high-quality display and can exhibit the long lifetime.

Further, the spacers which are arranged in the plurality of columns may be arranged in a staggered pattern in which the centers of the spacers are displaced between the neighboring columns in one direction.

Further, the plurality of spacers which constitute the column may have the same size or the different sizes in one direction.

Still further, some of the plurality of spacers which are arranged in the above-mentioned manner may be arranged to have long sides thereof directed in another direction which intersects the above-mentioned one direction.

By arranging the spacers in a plurality of columns and by setting the distance between the columns to 50 mm or less or by setting the distance between each two of the plurality of interval holding members to 50 mm or less, it is possible to completely eliminate the distortion of a display image attributed to the deflection of the substrate whereby it is possible to provide an image display device which can realize the large-sizing of a display size and the high-quality display and can exhibit the long lifetime. Further, it may be possible to allow the distance between the outermost spacer and the frame to be different between neighboring columns.

By forming the sealing material using amorphous frit glass, it is possible to achieve both of the adhesion and fixing of the spacers and substrate and the hermetic sealing of the frame and the substrates with high reliability whereby, not to mention the enhancement of the operability, it is possible to provide an image display device which can realize the large-sizing of a display size and the high-quality display and can exhibit the long lifetime.

### BRIEF DESCRIPTION OF THE SEVERAL VIEWS OF THE DRAWING

FIG. 1 is a schematic plan view showing one embodiment of an image display device of the present invention;

FIG. 2 is a schematic cross-sectional view taken along a line A-A in FIG. 1;

FIG. 3 is a schematic cross-sectional view showing an essential part shown in FIG. 1 in an enlarged manner;

FIG. 4 is a schematic plan view for explaining the positional relationship among parts shown in FIG. 1;

FIG. 5 is a schematic plan view showing an example of a spacer arrangement pattern of another embodiment of the image display device according to the present invention;

FIG. 6 is a schematic plan view showing an example of a spacer arrangement pattern of another embodiment of the image display device according to the present invention;

FIG. 7 is a view for explaining the relationship between a vitrifying component ratio in a fixing material used in the image display device of the present invention and an adhesion strength of spacers used in the image display device of the present invention;

FIG. 8 is a view for explaining the relationship between a vitrifying component ratio in a fixing material used in the image display device of the present invention and a resistance value of spacers used in the image display device of the present invention;

FIG. 9 is a view for explaining the relationship between the arrangement distance of spacers used in the image display device of the present invention and a deflection quantity of a substrate used in the image display device of the present invention;

FIG. 10 is a view for explaining the relationship between the arrangement distance of spacers used in the image display device of the present invention and a deflection quantity of a substrate used in the image display device of the present invention; and

FIG. 11 is a schematic cross-sectional view for explaining a conventional image display device.

### DETAILED DESCRIPTION OF THE INVENTION

Hereinafter, embodiments of the present invention are explained in detail in conjunction with attached drawings of the embodiments.

### Embodiment 1

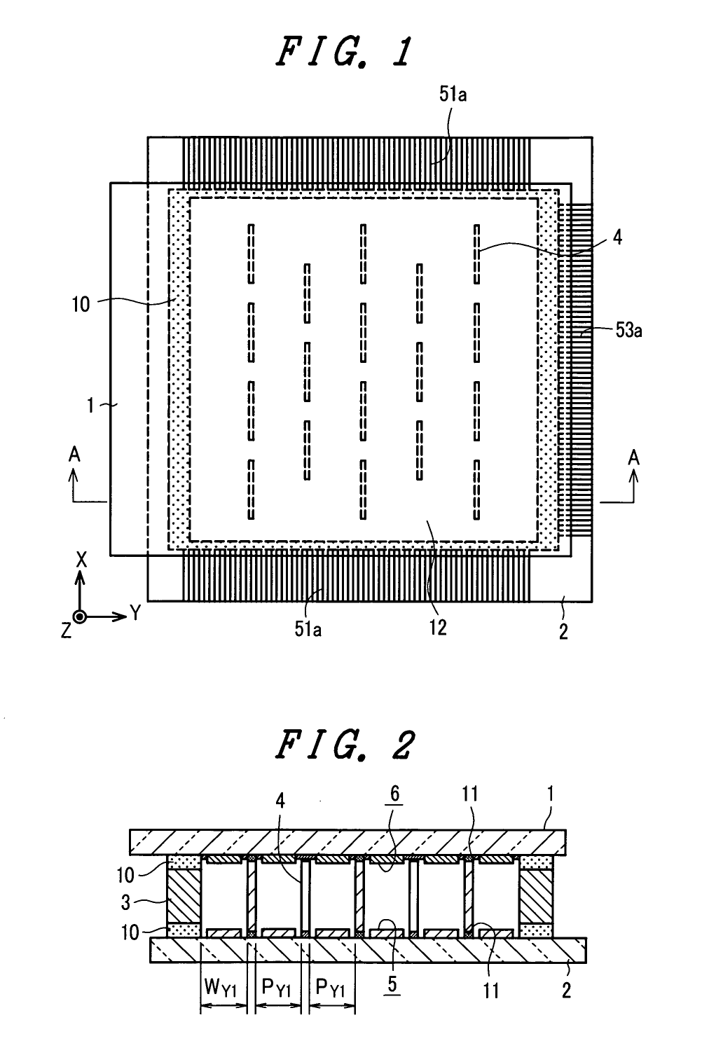

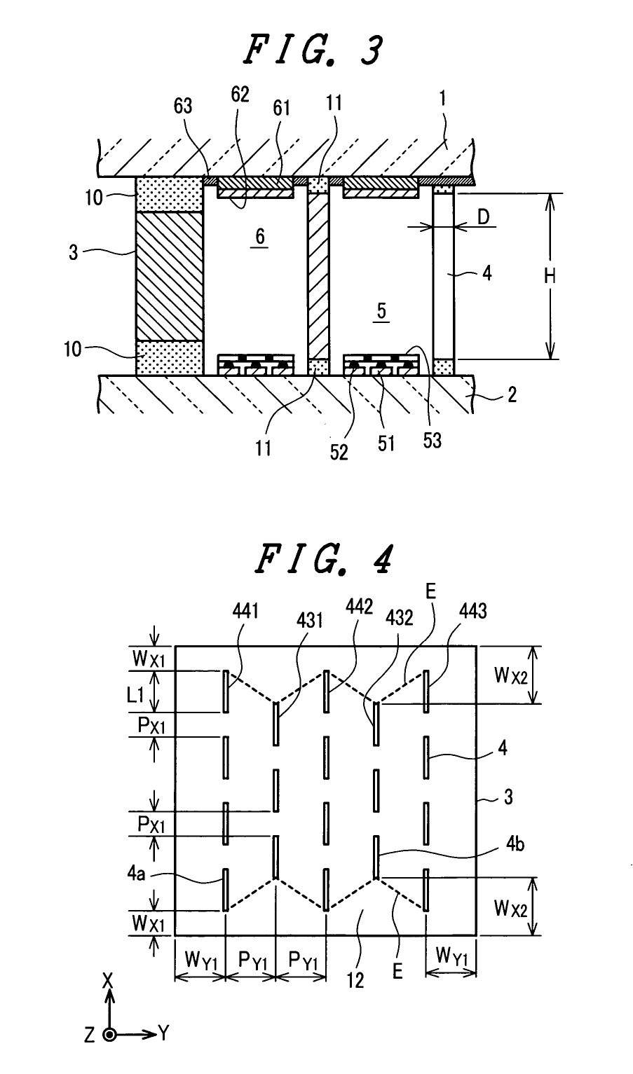

FIG. 1 to FIG. 4 show one example of an image display device according to the present invention, wherein FIG. 1 is a schematic plan view showing the schematic constitution of one example of a field-emission-type image display device as viewed from a face substrate side, FIG. 2 is a schematic cross-sectional view taken along a line A-A in FIG. 1, FIG. 3 is a cross-sectional view of an essential part in an enlarged manner of FIG. 2, and FIG. 4 is a schematic plan view for explaining the mutual positional relationship among parts shown in FIG. 1.

In FIG. 1 to FIG. 4, numeral 1 indicates a face substrate, numeral 2 indicates a back substrate, numeral 3 indicates a frame, numeral 4 indicates spacers, numeral 5 indicates electron emission elements, numeral 51 indicates cathode lines, numeral 51a indicates cathode-line lead terminals, numeral 52 indicates electron sources, numeral 53 indicates grid electrodes, numeral 53a indicates grid electrode lead terminals, numeral 6 indicates image forming members, numeral 61 indicates phosphor layers, numeral 62 indicates a metal back layer, numeral 63 indicates a black matrix (BM) film, numeral 10 indicates sealing materials, numeral 11 indicates sealing materials, and numeral 12 indicates a display region.

In FIG. 1 to FIG. 4, the face substrate 1 is constituted of a transparent glass plate or the like, while the back substrate 2 is preferably constituted of an insulation substrate which is formed of glass or ceramics such as alumina or the like in the same manner as the face substrate 1 and has a plate thickness of approximately several mm, for example, 3 mm. The frame 3 which is arranged between peripheral portions of both substrates 1, 2 is formed of a glass plate or a shaped product of frit glass or the like, is fixed to both substrates 1, 2 by way of the sealing materials 10, and holds a distance between the back substrate 1 and the face substrate 2 at a given size, for example, approximately 3 mm.

The plate-like spacers 4 are constituted of a thin ceramics plate made of alumina or the like and are arranged in the inside of a space defined between the back substrate 1 and the face substrate 2 in a state that the spacers 4 are erected on a substrate surface substantially vertically. A plurality of spacers 4 are arranged at a given pitch distance in a state that the spacers 4 have a long-side direction thereof aligned with the above-mentioned one direction (X direction) thus forming a column. A plurality of spacer columns are arranged at a given pitch distance in another direction (Y direction) which intersects the above-mentioned one direction orthogonally. Between the neighboring columns, the long-side center positions of the spacers 4 are displaced in one direction (X direction). That is, the spacers 4 are arranged in a staggered and dispersed manner.

In this embodiment, the columns (four-piece columns) 441, 442, 443 each of which arranges four pieces of spacers 4 having a thickness D, a length L1, and a height H and the columns (three-piece columns) 431, 432 each of which arranges three pieces of spacers 4 having a thickness D, a length L1, and a height H are provided. In the four-piece columns 441, 442, 443, the long sides of the spacers 4 are aligned with the above-mentioned one direction (X direction) and are arranged with the pitch distance Px1. In the three-piece columns 431, 432, the long sides of the spacers 4 are aligned with the above-mentioned one direction (X direction) and are arranged with the pitch distance Px1. The four-piece columns and the three-piece columns are configured to be arranged in parallel in another direction (Y direction) which intersects one direction alternately at a pitch Py1.

Further, in the four-piece columns 441 to 443, the distance in the arrangement direction between the outermost spacer 4a of each column and the frame 3 is set as Wx1, while in the three-piece columns 431, 432, the distance in the arrangement direction between the outermost spacer 4b of each column and the frame 3 is set as Wx2 (Wx2>Wx1) and an envelope E which connects the outermost sides of these columns exhibits a serrated shape. Further, the distance in the arrangement direction between the outermost columns 441, 443 and the frame 3 is set to Wy1 (Wy1≈Wx1).

Further, the three-piece columns 431, 432 which are arranged close to the four-piece columns 441 to 443 have the center in the longitudinal-direction of the spacers 4 made different from each other thus providing the dispersed arrangement in which the spacers 4 are arranged in a staggered pattern.

The number and the arrangement position of the spacers are set such that a stress attributed to an atmospheric pressure is substantially uniformly applied to the respective arranged spacers 4. Further, the spacers 4 are arranged in a scattered manner so as to prevent the deflection and damages of the substrate and the generation of buckling of the spacers. Each spacer 4 has upper and lower ends thereof fixed to both substrates 1, 2 by way of the fixing material 11. Further, the spacers 4 hold a distance between both substrates 1, 2 to a given size in cooperation with the frame 3.

A group of electron emission elements 5 which are arranged on an inner surface of the back substrate 2 include the cathode lines 51, the electron sources 52, the grid electrodes 53 and the like.

A plurality of cathode lines 51 extend in one direction (X direction) and are arranged in parallel in another direction (Y direction) on the inner surface of the back substrate 2. The cathode lines 51 have end portions thereof connected to cathode line lead lines 51a. The cathode line lead lines 51a are divided in two along two sides of the back substrate 2 and, thereafter, are pulled out to the outside of a hermetic sealing portion.

The cathode lines 51 can be formed by vapor deposition or by printing. In forming the cathode lines 51 by printing, a silver paste which is formed by mixing low-fusion glass which exhibits the insulation property into conductive silver particles having a particle size of several μm (for example, 1 to 5 μm) is printed to form a film of a large thickness and the film is baked at a temperature of approximately 600° C.

Further, the control electrodes 53 are arranged above the cathode lines 51 in an insulated manner from the cathode lines 51. The control electrodes 53 have end portions thereof connected to control electrode lead lines 53a. The control electrode lead lines 53a are pulled out to the outside of the hermetic sealing portion at another one side of the back substrate 2.

Further, the electron sources 52 which are arranged on the cathode line 51 at a given pitch are formed of an electron emission element of metal-insulator-metal (MIM) type, an electron emission structure which utilizes an electron emission phenomenon based on a quantum theory tunneling effect (also referred to as “a surface conduction type electron source”) element, or a diamond film, a graphite film and carbon nanotubes or the like. As a method for forming the electron sources 52, for example, a carbon nanotube paste is printed on a surface of the cathode line 51 which is formed by printing and baking and is baked in a vacuum at a temperature of 590° C., for example.

In this embodiment, as the carbon nanotube paste, a paste which is formed by dispersing single-wall carbon nanotubes in ethyl cellulose and terpineol is used.

Here, although the explanation has been made with respect to the single-wall carbon nanotubes above, the multi-wall carbon nanotubes or the carbon nanofibers may be used. Further, besides these materials, for example, diamond, diamond-like carbon, graphite, amorphous carbon and the like can be used. Further, it is also possible to use the mixture of these materials.

Further, the image forming member 6 arranged on the face substrate 1 includes the phosphor layer 61, the metal back layer 62 which is formed on the phosphor layer 61 and the black matrix (BM) film 63. This constitution is substantially equal to the constitution of a conventional color-cathode-tube phosphor screen.

Electrons emitted from the electron sources 52 which are arranged on the cathode lines 51 receive a control by electron passing holes formed in the control electrodes 53 to which a grid voltage of approximately 100V is applied and pass through the electron passing holes. Then, the electrons advance to the image forming members 6 to which an anode voltage of several KV to 10 and some KV is applied, pass through the metal back layers 62 (anodes) and impinge on the phosphor layers 61 thus allowing the phosphor layers 61 to emit light to perform a desired display on a video image screen.

Then, a plurality of pixels which are arranged in a matrix array are formed on a display region 12 of the face substrate. In general, with respect to the above-mentioned pixels, three pixels allocated to red (R), green (G) and blue (B) form a unit pixel. With the provision of the unit pixels, it is possible to display color images.

Next, the sealing material 10 is made of amorphous frit glass which is, for example, composed of 75 to 80 wt % of PbO, approximately 10 wt % of B₂O₃ and 10 to 15 wt % of balance. The sealing material is arranged on upper and lower end surfaces of the frame 3 and hermetically seals peripheral portions of the face substrate 1 and the back substrate 2 which are stacked in the Z direction. Due to such hermetic sealing, the frame 3, the face substrate 1 and the back substrate 2 constitute a vacuum envelope.

Here, the hermetic sealing performed by way of the sealing material 10 is performed in a nitrogen atmosphere at a temperature of approximately 430° C. and, thereafter, the heating at a temperature of approximately 350° C., the evacuation and the sealing follow. Here, the Z direction means the direction which is orthogonal to substrate surfaces of the back substrate 2 and the face substrate 1 which are overlapped to each other.

Next, the fixing material 11 which fixes the spacers 4 and both substrates 1, 2 is constituted of a mixture of 50 wt % of a conductive component which is formed of conductive silver particles having a particle size of several μm to several tens μm (for example, approximately 3 to 10 μm) and 50 wt % of low-melting-point frit glass which constitutes a vitrifying component which exhibits the insulation property. The fixing material 11 fixes the upper and lower end surfaces 41 of the spacers 4 and both substrates 1, 2. The low-melting-point frit glass is constituted of the composition which contains, for example, SiO₂, B₂O₃ and PbO as main components.

The fixing material 11 can be used in a state that the vitrifying component falls in a range of 10 to 90 wt %. When the vitrifying component of the fixing material 11 is less than 10 wt %, the adhesion strength becomes insufficient and hence, the spacers are removed or inclined whereby it becomes difficult to hold the parallelism between both substrates 1, 2 and, at the same time, it is difficult to ensure the desired panel strength. Further, there exist the possibility of the occurrence of defects such as the rupture of the spacers and damages on electrodes attributed to the rupture of the spacers.

Further, when the vitrifying component of the fixing material 11 is less than 10 wt %, since the adhesion temperature at the time of adhering the spacers and the substrate is set based on the melting characteristics of the conductive component, there arises a problem with respect to the heat resistance of the electrodes, particularly the heat resistance of the electron sources 52. That is, there arise problems that the electrodes are damaged in the high-temperature adhesion and the adhesion strength becomes insufficient in the low-temperature adhesion thus giving rise to a drawback with respect to use as a display device.

On the other hand, when the vitrifying component exceeds 90 wt %, an electric resistance value of bonding portions becomes high and a potential in the vicinity of the spacer 4 becomes unstable and hence, there arises the difference in a beam quantity among the electron beams which pass in the vicinity of the spacer 4 whereby the fluctuation of brightness and color tone is generated on a phosphor screen thus giving rise to a defect with respect to the display quality which does not allow the practical use of the display device.

Accordingly, the vitrifying component ratio can be used in a range of 10 to 90 wt %, while it is difficult to use the vitrifying component ratio which falls outside the range. Further, although the detailed explanation will be made later, it is desirable that the vitrifying component ratio falls within a range of 20 to 80 wt %, and it is more preferable that the vitrifying component ratio is approximately 50 wt % in view of the electric and mechanical properties as well as the operability.

Further, as the conductive components, beside the above-mentioned silver, for example, one selected from a group consisting of nickel, gold, platinum and the like or an alloy which contains such metals as a main component can be used. It is desirable to use a granular material which constitutes a sintered body of these metals. Particularly, it is preferable to use silver and nickel in view of the stable supply, inexpensive cost and, further, operability.

The fixing material 11 having the above-mentioned composition is arranged between the upper and lower end surfaces of the spacers 4 and both substrates 1, 2 and, thereafter, for example, the fixing material 11 is heated and melted by a laser heating device or an infrared heating device which is formed of a combination of an infrared ray lamp and an elliptical reflection mirror so as to adhere and fix the spacers 4 and both substrates 1, 2.

According to the constitution of this embodiment, it is possible to achieve the assurance of the fixing of spacers and the substrates and the assurance of conductive property and hence, it is possible to ensure the parallelism of both substrates and the panel strength.

Further, due to the proper arrangement of the spacers, it is possible to prevent the occurrence of damages on the spacers per se and, at the same time, due to the arrangement pattern indicated by an envelope E, it is possible to obtain the desired holding strength with the small number of spacers. Eventually, it is possible to enhance the operability.

### Embodiment 2

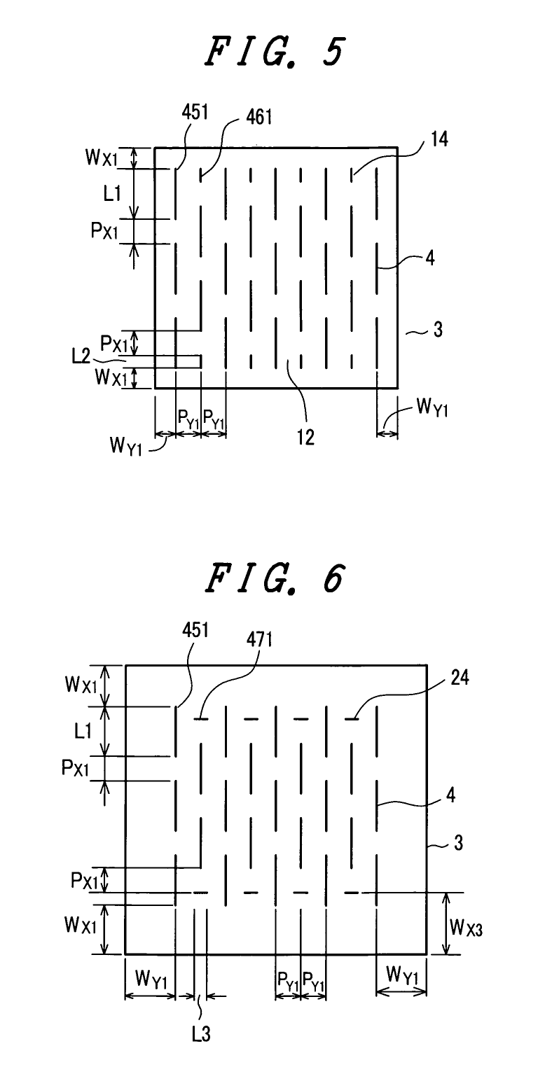

FIG. 5 is a plan view showing an example of a spacer arrangement pattern of another embodiment of the display device according to the present invention. In the drawing, parts identical with the parts shown in the drawing or parts having functions identical with the functions of the parts shown in the above-mentioned drawing are given same symbols. The display device includes a first-kind column 451 which is formed by arranging first-kind spacers 4 having a length L1 in one direction and a composite column 461 which is comprised of the above-mentioned first-kind spacers 4 and the second-kind spacers 14 having a length L2. The spacers are arranged in a staggered arrangement in a state that the first-kind columns 451 and the composite columns 461 are alternately arranged in parallel in another direction which intersects the above-mentioned one direction orthogonally. In this embodiment 2, a long spacer is used as the first-kind spacers 4 and a short spacer 14 which is shorter than the long spacer 4 is used as the second-kind spacers. The length L2 of the long side of the second-kind spacer 14 is shorter than the length L1 of the long side of the first-kind spacer 4, while a thickness and a height of the second-kind spacer 14 are equal to a thickness and a height of the first-kind spacer 4.

By properly combining two kinds of spacers which differ in size, it is possible to hold the whole area of a display region 12 substantially uniformly and, at the same time, it is possible to set distances Wx1, Wy1 between the spacers 4, 14 and a frame 3 substantially uniform over the whole periphery of the display region 12. That is, by complementarily arranging the short spacers 14 which are smaller than the long spacers 4 in size in the region where the long spacers 4 cannot be arranged, it is possible to set distances Px1, Py1 between the spacers and the distances Wx1, Wy1 between the outermost spacers and the frame 3 to a substantially equal value and hence, it is possible to hold the whole area of a display region 12 substantially uniformly.

In this embodiment 2, by arranging plural kinds of spacers consisting of the long spacers 4 and the short spacers 14 having the size different from the long spacers 4 in combination, the whole area of the substrate can be held uniformly. Accordingly, a stress attributed to an atmospheric pressure is substantially uniformly applied to the respective long and short spacers 4, 14 thus preventing the deflection and damages of the substrate and the generation of buckling of the spacers whereby it is possible to provide the highly reliable display device which can ensure the parallelism of both substrates and the panel strength.

Further, by setting the distances Wx1, Wy1 between the outermost spacers and the frame 3 substantially equal to the distances Px1, Py2 between the spacers, the outermost spacers 4, 14 hardly receive the influence of fixing of the frame 3 and the sealing material 10 and hence, it is possible to hold the whole area of a display region 12 substantially uniformly.

### Embodiment 3

FIG. 6 is a plan view showing an example of a spacer arrangement pattern of another embodiment of the display device according to the present invention. In the drawing, parts identical with the parts shown in the above-mentioned drawing or parts having functions identical with the functions of the parts shown in the above-mentioned drawing are given same symbols. The display device of this embodiment 3 includes a first-kind column 451 which is formed by arranging first-kind spacers 4 in one direction and a second composite column 471 which is comprised of the above-mentioned spacers 4 and third-kind spacers 24 in combination. A length L3 of the third-kind spacers 24 is set shorter than the length L1 of the first-kind spacers 4. Further, long sides of the third-kind spacers 24 are aligned with another direction which is orthogonal to the above-mentioned one direction. The first-kind columns 451 and the second composite columns 471 are alternately arranged in parallel in another direction which is orthogonal to the above-mentioned one direction. Further, the spacers are arranged in a staggered manner. A thickness and a height of the third-kind spacer 24 are equal to a thickness and a height of the spacer 4, while a distance Wx3 between the third-kind spacer 24 and the frame 3 has the relationship Wx3>Wx1.

In this embodiment 3, with the use of the short spacers 24 and the long spacers 4, to the respective spacers 4, 24, the substantially uniform load is applied corresponding to the respective sizes of the spacers 4, 24 and hence, the distance between both substrates can be held at a given size and, at the same time, it is possible to prevent the deflection and damages of the substrate and the damages on the spacers. Further, it is possible to provide a reinforcing effect not only to the above-mentioned one direction but also to another direction orthogonal to the above-mentioned one direction. Further, by providing the relationship Wx3>Wx1, it is possible to uniformly hold the whole area of the display region.

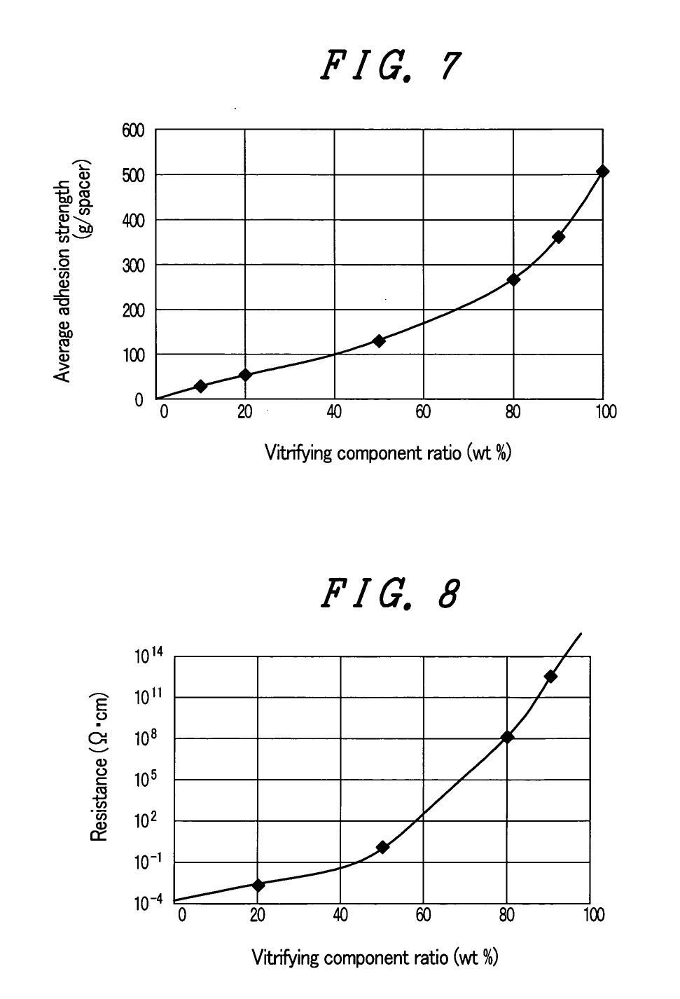

Next, FIG. 7 is a drawing which explains the relationship between a vitrifying component ratio in the fixing material used in the image display device of the present invention and an adhesion strength of the spacers used in the image display device of the present invention. In FIG. 7, the vitrifying component ratio (wt %) in the fixing material is taken on an axis of abscissas and an average adhesion strength (g/spacer) of the spacers is taken on an axis of ordinates. Although the required adhesion strength of the spacers in this type of display device is set by taking a safety coefficient at the time of assembling into consideration, it is empirically known that it is possible to obtain a sufficient adhesion strength by setting the safety coefficient to 100 times or more of the weight of the spacer.

In FIG. 7, although a spacer having a thickness of 0.1 mm, a length of 85 mm, a height of 3 mm, a specific gravity of 4.1 is used as the spacers, the spacers having such a shape and size requires the adhesion strength of approximately 10 g or more. In FIG. 7, when the vitrifying component ratio is 10%, the average adhesion strength becomes approximately 30 (g/spacer). Since the 3σ value is approximately 1/3 of the average adhesion strength, by taking the above-mentioned conditions into consideration, it is possible to obtain the required adhesion strength provided that the vitrifying component ratio is approximately 10% or more and it is possible to avoid the removal of spacers at the time of assembling. Accordingly, it is necessary to ensure the vitrifying component ratio of 10% or more.

Further, when this value exceeds 20%, as can be clearly understood from FIG. 7, the average adhesion strength is increased along with the increase of the vitrifying component ratio. That is, when the value is 50%, the average adhesion strength becomes approximately 130 (g/spacer), when the value is 90%, the average adhesion strength becomes approximately 350 (g/spacer), and when the value is 100%, the property of the average adhesion strength is rapidly changed and the average adhesion strength becomes approximately 500 (g/spacer) whereby the spacers are strongly fixed.

However, when the vitrifying component ratio is 100%, since the fixing material is constituted of only the vitrifying component, a resistance value becomes excessively high as described later thus giving rise to a drawback that the spacers are charged. In this manner, there arises the possibility that a locus of the electron beam is disturbed by charging. There also arises the possibility that the substrates and the spacers are excessively strongly fixed to each other thus hampering the recycling operation. Accordingly, it is desirable that the above-mentioned vitrifying component ratio in the fixing material is 90% or less.

Next, FIG. 8 is a view for explaining the relationship between a vitrifying component ratio in a fixing material used in the image display device of the present invention and a resistance value of spacers used in the image display device of the present invention. In FIG. 8, the vitrifying component ratio (wt %) in the fixing material is taken on an axis of abscissas and the resistance value (Ω·cm) of the spacers is taken on an axis of ordinates.

As can be clearly understood from FIG. 8, when the vitrifying component ratio exceeds 90%, the fixing material has the constitution similar to the fixing material which is formed of only the vitrifying component and hence, the resistance value becomes a value which exceeds 10¹² Ω·cm. When the vitrifying component exhibits such high resistance, there arises a drawback that the spacers are charged and this induces a drawback that a locus of electron beam is disturbed by charging. Accordingly, it is necessary to set the vitrifying component ratio to 90 wt % or less in view of the resistance value.

Further, it is preferable that the resistance value is 10¹⁰ Ω·cm or less and hence, it is desirable to set the vitrifying component ratio to 80 wt % or less.

On the other hand, when the vitrifying component ratio is lowered, the resistance value is also lowered as shown in the drawing. However, it is necessary to prevent both substrates from becoming conductive with each other and hence, it is preferable to set the vitrifying component ratio to 10 wt % or more, and it is more preferable to set the vitrifying component ratio to 20 wt % or more.

Here, the material, the individual size, the number of arrangement, the arrangement pattern and the like of the spacers are determined by taking the sizes of the substrates, the number of pixels, the deflection quantity of substrate, the operability and the like into consideration. Accordingly, with respect to the respective sizes of the spacers which are used in the above-mentioned FIG. 7, it is possible to adopt the specification which increases some lengths from several times to 10 and some times in view of the operability. However, the thickness and the height are highly likely to be set to values within several times in view of the constitution of the display device and hence, it is apparent that the above-mentioned vitrifying component ratio is not limited to the above-mentioned embodiments.

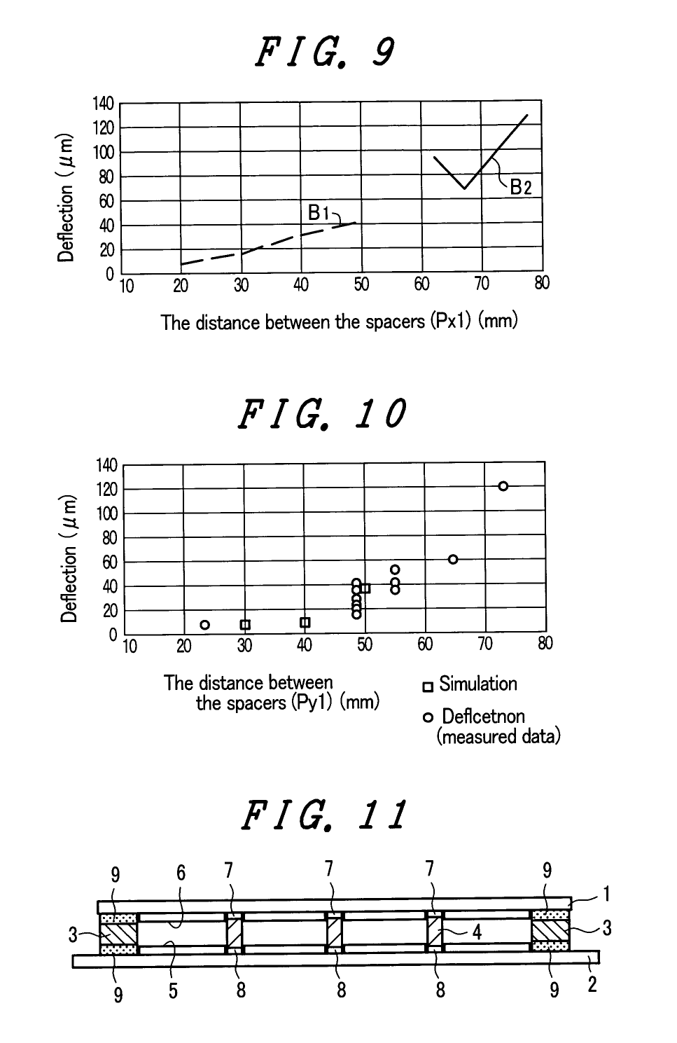

Next, FIG. 9 and FIG. 10 are views for explaining the relationship between the arrangement distance of spacers used in the image display device of the present invention and a deflection quantity of a substrate used in the image display device of the present invention. FIG. 9 shows the relationship between the pitch distance (Px1) of the spacers in one direction of one arrangement direction (X direction) and the deflection quantity and FIG. 10 shows the relationship between the pitch distance (Py1) of the spacers in another direction of one arrangement direction (Y direction) which intersects one direction and the deflection quantity.

Here, in FIG. 9 and FIG. 10, as the spacers, spacers which have the specification of a ceramic plate having a thickness of 0.1 mm, a height of 3 mm and a length of 85 mm are used, while as both substrates, a 5-inch-size high strain point glass plate having a thickness of 2.8 mm is used. Further, as the fixing material, a silver paste having 50 wt % of vitrifying component is used.

First of all, in FIG. 9, the pitch distance (Px1) of the spacers in the above-mentioned arrangement direction (X direction) and the distance (Wx1) in the arrangement direction between the spacer 4 on the outermost column and the frame 3 are taken on an axis of abscissas and the deflection quantity is taken along an axis of ordinates. Further, a dotted line B1 indicates the deflection quantity at a center portion of the substrate and a solid line B2 indicates the deflection quantity at an end portion of the substrate.

As shown in FIG. 9, when the pitch distance Px1 of the spacers is 20 mm, the deflection quantity at the center portion is approximately 10 μm and when the pitch distance Px1 is increased to 50 mm, the deflection quantity becomes approximately 40 μm. In general, when the deflection quantity of the substrate is increased, the reflection on the screen is generated at the time of performing a display and hence, there arises a drawback that the display quality is deteriorated. To ensure the display quality by overcoming this drawback, it is necessary to limit the deflection quantity such that the maximum allowable deflection quantity of the substrate is approximately 40 μm. Accordingly, it is preferable to set the above-mentioned pitch distance Px1 to 50 mm or less (excluding 0, this definition being applicable hereinafter).

On the other hand, with respect to the deflection quantity of an end surface of the substrate indicated by the solid line B2, irrespective of the value of the above-mentioned pitch distance Px1, when the distance Wx1 in the above-mentioned arrangement direction exceeds 60 mm, the deflection quantity exceeds 60 μm and the reflection on the screen is generated. Accordingly, by setting the distance Wx1 in the arrangement direction at the end surface to 50 mm or less in the same manner as the pitch distance Px1 at the center portion, it is possible to suppress the deflection quantity within the given range.

Next, in FIG. 10, the pitch distance (Py1) of the spacers in the above-mentioned parallel arrangement direction (Y direction) and the distance (Wy1) in the parallel arrangement direction between the spacer 4 on the outermost column and the frame 3 are taken on an axis of abscissas and the deflection quantity is taken along an axis of ordinates. Further, a square mark indicates calculated values and a circular mark indicates actually measured values. In FIG. 10, when the pitch distance (Py1) of the spacers and the distance (Wy1) in the parallel direction are approximately 55 mm or less, the deflection quantity also becomes 40 μm or less and hence, the generation of the reflection can be substantially eliminated. Further, when the pitch distance (Py1) of the spacers and the distance (Wy1) in the parallel arrangement direction becomes 50 mm or less, it is possible to eliminate the generation of the reflection more reliably. Accordingly, by setting the pitch distance (Py1) of the spacers and the distance (Wy1) in the arrangement direction at the end surface to 50 mm or less in the same manner, it is possible to surely eliminate the reflection.

Here, the present invention is not limited to the above-mentioned embodiments and various modifications can be made without departing from the technical concept of the present invention.

In this manner, by specifying the composition of the fixing material of the spacers and by taking the arrangement pattern into consideration, it is possible to provide the display device which can ensure the parallelism of both substrates, the panel strength and the conductive properties, can enable the large-sizing of the display size and the high-quality display, and can prolong the lifetime.

1. An image display device comprising:
a vacuum envelope which includes a face substrate which has an image display region, a back substrate which includes a plurality of electron sources and faces the face substrate in an opposed manner with a given distance therebetween, and a frame which surrounds the image forming region and is arranged between the face substrate and the back substrate; and
a plurality of spacers which are arranged in the inside of the envelope and are fixed to the face substrate and the back substrate respectively, wherein
the spacers are fixed by way of a fixing material which contains a conductive component and a vitrifying component, and a rate of the vitrifying component in the fixing material is set to 10 to 90 wt %.

2. An image display device according to claim 1, wherein the rate of vitrifying component of the fixing material is set to 20 to 80 wt %.

3. An image display device according to claim 1, wherein the rate of vitrifying component of the fixing material is set to 50 wt %.

4. An image display device according to claim 1, wherein the conductive component of the fixing material is constituted of sinterable metal particles which are made of one selected from a group consisting of silver, gold, nickel and platinum or an alloy which contains one selected from a group consisting of silver, gold, nickel and platinum as a main component.

5. An image display device according to claim 1, wherein the vitrifying component is made of frit glass.

6. An image display device according to claim 1, wherein the spacers are formed of a plate-like ceramic member.

7. An image display device according to claim 1, wherein a plurality of spacers are arranged at a given pitch in one direction and are arranged in a plurality of columns in another direction which intersects one direction.

8. An image display device according to claim 7, wherein the spacers which are arranged in the plurality of columns are arranged in a staggered pattern in which the centers of the spacers are displaced between the neighboring columns in one direction.

9. An image display device according to claim 7, wherein some of the plurality of arranged spacers are arranged to have long sides thereof in another direction which intersects one direction.

10. An image display device according to claim 7, wherein the spacers are arranged in a plurality of columns and the distance between the columns is set to 50 mm or less.

11. An image display device according to claim 7, wherein the distance between each two of the plurality of arranged spacers is set to 50 mm or less.

12. An image display device according to claim 7, wherein the distance between the outermost spacer and the frame is made different between neighboring columns.

13. An image display device according to claim 1, wherein the sealing is formed of amorphous frit glass.
